(19) United States
(12) Patent Application Publication
(10) Pub. No.: US 2017/0002966 A1
(43) Pub. Date: Jan. 5, 2017

(54) STANDOFF APPARATUS FOR FREEZE PROTECTION

(71) Applicant: Thomas William Perry, Charlotte, NC (US)

(72) Inventor: Thomas William Perry, Charlotte, NC (US)

(21) Appl. No.: 15/198,368

(22) Filed: Jun. 30, 2016

Related U.S. Application Data
(60) Provisional application No. 62/186,368, filed on Jun. 30, 2015.

(51) Int. Cl. F16L 53/00; B23P 19/00

(52) U.S. Cl. CPC F16L 53/002; B23P 19/00

(57) ABSTRACT

A system includes a vessel containing stored water, a pipe connected to the vessel which transports water to a facility, and a steam tracer pipe for heating the pipe. The system further includes a standoff apparatus installed on the pipe with the steam tracer received therein. The standoff apparatus comprises a trace receiving area configured to receive a steam trace, the trace receiving area comprising three curved cutout portions defining four contact points, and two elevating leg portions. The steam tracer is received within the trace receiving area, and the standoff apparatus contacts the steam tracer only at the four contact points. The standoff apparatus contacts the pipe only at the two elevating leg portions.

### CROSS-REFERENCE TO RELATED APPLICATION

The present application is a U.S. nonprovisional patent application of, and claims priority under 35 U.S.C. §119(e) to, U.S. provisional patent application Ser. No. 62/186,368, filed Jun. 30, 2015, which provisional patent application is hereby incorporated herein by reference.

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND OF THE INVENTION

The present invention generally relates to facilitating the heating of piping.

Many processing facilities require large supplies of water that can be accessed on demand with minimal flow restriction. Because tanks and vessels for storing water are usually too large to keep inside facilities, they are often located outdoors and accessed through piping. However, cold environments have the potential to freeze pipelines between a tank and a facility, causing process down-time and risking costly damage to equipment and infrastructure. Sometimes, when insulation alone is not adequate to prevent freezing, thermal tracing is used to keep water flowing and sustain process continuity. Steam tracing is a common and preferred method to prevent freezing since many plants already generate steam, and a spacer/standoff is sometimes used to prevent a trace from transferring too much heat to a pipe. However, many freeze protection standoffs: allow steam tracing to contact the pipe to be heated, provide non-uniform heating, are installed inconsistently, and/or promote internal corrosion of piping.

Needs exist for improvement in standoff apparatus. These needs and other needs are addressed by one or more aspects of the present invention.

### SUMMARY OF THE INVENTION

The present invention includes many aspects and features. Moreover, while many aspects and features relate to, and are described in, the context of steam tracing for a pipe for a facility, the present invention is not limited to use only in this context, as will become apparent from the following summaries and detailed descriptions of aspects, features, and one or more embodiments of the present invention.

Accordingly, one aspect of the present invention relates to a system comprising a process pipe; a standoff apparatus secured to the pipe via a plurality of spaced securing bands, the standoff apparatus comprising a trace receiving channel configured to receive a tracer tube, the trace receiving channel having a profile configured to effect only tangential contact with a tracer tube received within the trace receiving channel, and two elevating leg portions; a tracer received within the trace receiving channel; insulation surrounding the standoff apparatus and the spaced securing bands, the insulation trapping heat from the tracer received within the trace receiving channel; wherein, so as to minimize conductive heat transfer from the tracer to the process pipe, the tracer is not in contact with the process pipe, the standoff apparatus contacts the pipe only at the two elevating leg portions, and the tracer received within the tracer channel is in only tangential contact with the standoff apparatus.

In a feature of this aspect, the tracer comprises a steam tracer.

In a feature of this aspect, the spaced securing bands comprise stainless steel securing bands.

In a feature of this aspect, the standoff apparatus comprises aluminum.

In a feature of this aspect, the standoff apparatus comprises a thermally resistant polymer coating.

In a feature of this aspect, the process pipe comprises a water pipe.

In a feature of this aspect, the standoff apparatus has a size profile to fit 2″-12″ schedule 40 pipe.

Another aspect relates to a system comprising a process pipe; a standoff apparatus secured to the pipe via a plurality of spaced securing bands, the standoff apparatus comprising a trace receiving channel configured to receive a tracer tube, the trace receiving channel having a profile configured to effect only tangential contact with a tracer tube received within the trace receiving channel, and two elevating leg portions; a tracer received within the trace receiving channel; insulation surrounding the standoff apparatus and the spaced securing bands, the insulation trapping heat from the tracer received within the trace receiving channel; wherein, so as to minimize conductive heat transfer from the tracer to the process pipe, the tracer is not in contact with the process pipe, the standoff apparatus contacts the pipe only at the two elevating leg portions, and the tracer received within the tracer channel is in only tangential contact with the standoff apparatus; wherein the spaced securing bands do not secure the tracer so as to allow the tracer to be withdrawn from the trace receiving channel from a lateral end without removing the insulation or unsecuring the spaced securing bands.

Another aspect relates to a method of replacing a tracer without uninstalling insulation comprising, with respect to a system including a process pipe; a standoff apparatus secured to the pipe via a plurality of spaced securing bands, the standoff apparatus comprising a trace receiving channel configured to receive a tracer tube, the trace receiving channel having a profile configured to effect only tangential contact with a tracer tube received within the trace receiving channel, and two elevating leg portions; a tracer received within the trace receiving channel; insulation surrounding the standoff apparatus and the spaced securing bands, the insulation trapping heat from the tracer received within the trace receiving channel; wherein, so as to minimize conductive heat transfer from the tracer to the process pipe, the tracer is not in contact with the process pipe, the standoff apparatus contacts the pipe only at the two elevating leg portions, and the tracer received within the tracer channel is in only tangential contact with the standoff apparatus; wherein the spaced securing bands do not secure the tracer so as to allow the tracer to be withdrawn from the trace receiving channel from a lengthwise end without removing the insulation or unsecuring the spaced securing bands; withdrawing, from a lengthwise end of the system, the tracer from the trace receiving channel without removing the insulation or unsecuring the spaced securing bands; inserting, via a lengthwise end of the system, a new tracer into the tracer receiving channel without removing the insulation or unsecuring the spaced securing bands.

Another aspect relates to a system which includes a vessel containing stored water, a pipe connected to the vessel which transports water to a facility, and a steam tracer pipe for heating the pipe. The system further includes a standoff apparatus installed on the pipe with the steam tracer received therein. The standoff apparatus comprises a trace receiving area configured to receive a steam trace, the trace receiving area comprising three curved cutout portions defining four contact points, and two elevating leg portions. The steam tracer is received within the trace receiving area, and the standoff apparatus contacts the steam tracer only at the four contact points. The standoff apparatus contacts the pipe only at the two elevating leg portions.

Another aspect relates to a standoff apparatus which comprises a trace receiving area configured to receive a steam trace, the trace receiving area comprising three curved cutout portions defining four contact points, and two elevating leg portions.

Another aspect relates to a method of installing a standoff apparatus.

Another aspect relates to a method of making a standoff apparatus.

In addition to the aforementioned aspects and features of the present invention, it should be noted that the present invention further encompasses the various possible combinations and subcombinations of such aspects and features. Thus, for example, any aspect may be combined with an aforementioned feature in accordance with the present invention without requiring any other aspect or feature.

### BRIEF DESCRIPTION OF THE DRAWINGS

One or more preferred embodiments of the present invention now will be described in detail with reference to the accompanying drawings, wherein the same elements are referred to with the same reference numerals, and wherein,

FIG. 1 illustrate a profile view of an extruded aluminum, continuous, steam-trace standoff apparatus in accordance with one or more preferred implementations;

FIGS. 2-3 illustrate profile views of exemplary systems utilizing standoff apparatus in accordance with one or more preferred implementations;

FIGS. 4-5 illustrate fanciful perspective views of a system utilizing a standoff apparatus in accordance with one or more preferred implementations.

### DETAILED DESCRIPTION

As a preliminary matter, it will readily be understood by one having ordinary skill in the relevant art (“Ordinary Artisan”) that the present invention has broad utility and application. As should be understood, any embodiment may incorporate only one or a plurality of the above-disclosed aspects of the invention and may further incorporate only one or a plurality of the above-disclosed features. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. As should be understood, any embodiment may incorporate only one or a plurality of the above-disclosed aspects of the invention and may further incorporate only one or a plurality of the above-disclosed features. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof. It is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Regarding applicability of 35 U.S.C. §112(f), no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

Referring now to the drawings, one or more preferred embodiments of the present invention are next described. The following description of one or more preferred embodiments is merely exemplary in nature and is in no way intended to limit the invention, its implementations, or uses.

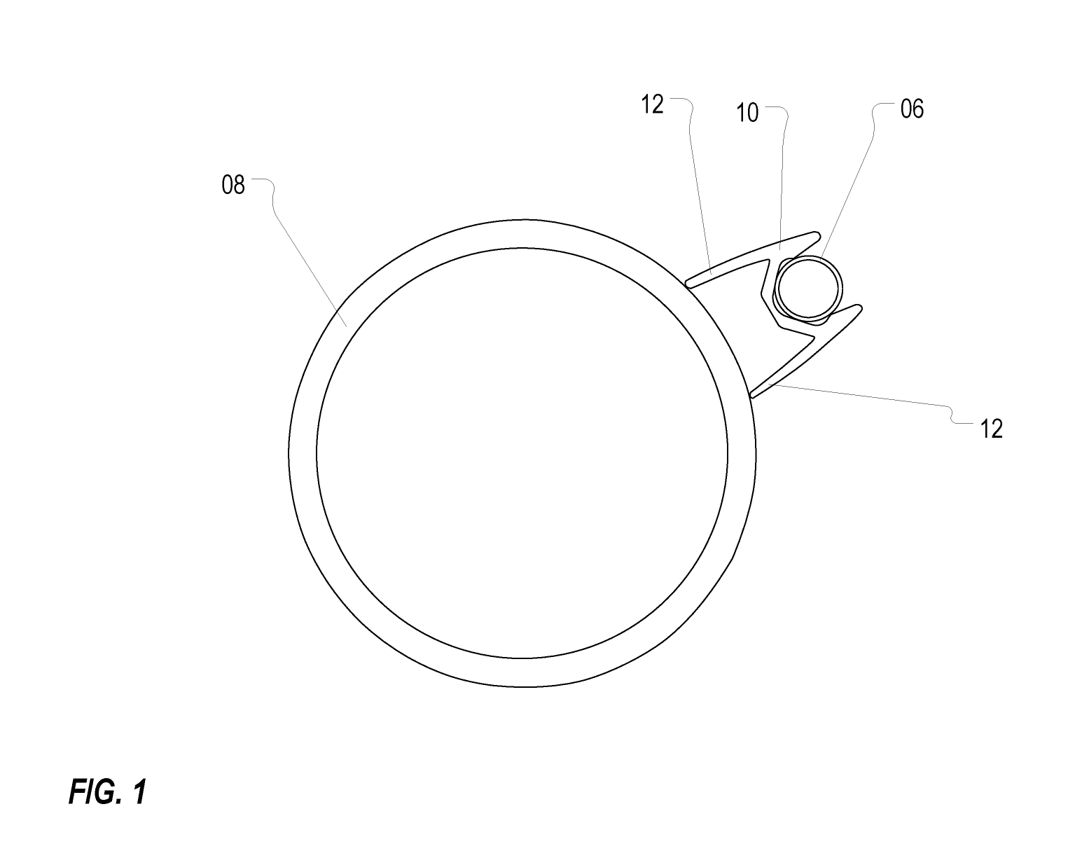

FIG. 1 is a profile view illustrating an extruded aluminum, continuous, steam-trace standoff apparatus 10 in accordance with one or more preferred implementations. The standoff apparatus 10 is designed to facilitate protection of process and water supply piping from freezing. For example, when installed on a surface of a pipe 08 and receiving a stainless steel steam trace tube 06, as illustrated in FIG. 1, the standoff apparatus creates air space between the stainless steel steam trace tube and the surface of the pipe, preventing a direct interface between them. As illustrated, only tangential contact is made between the standoff apparatus, the pipe, and the steam trace to minimize heat transfer through conduction.

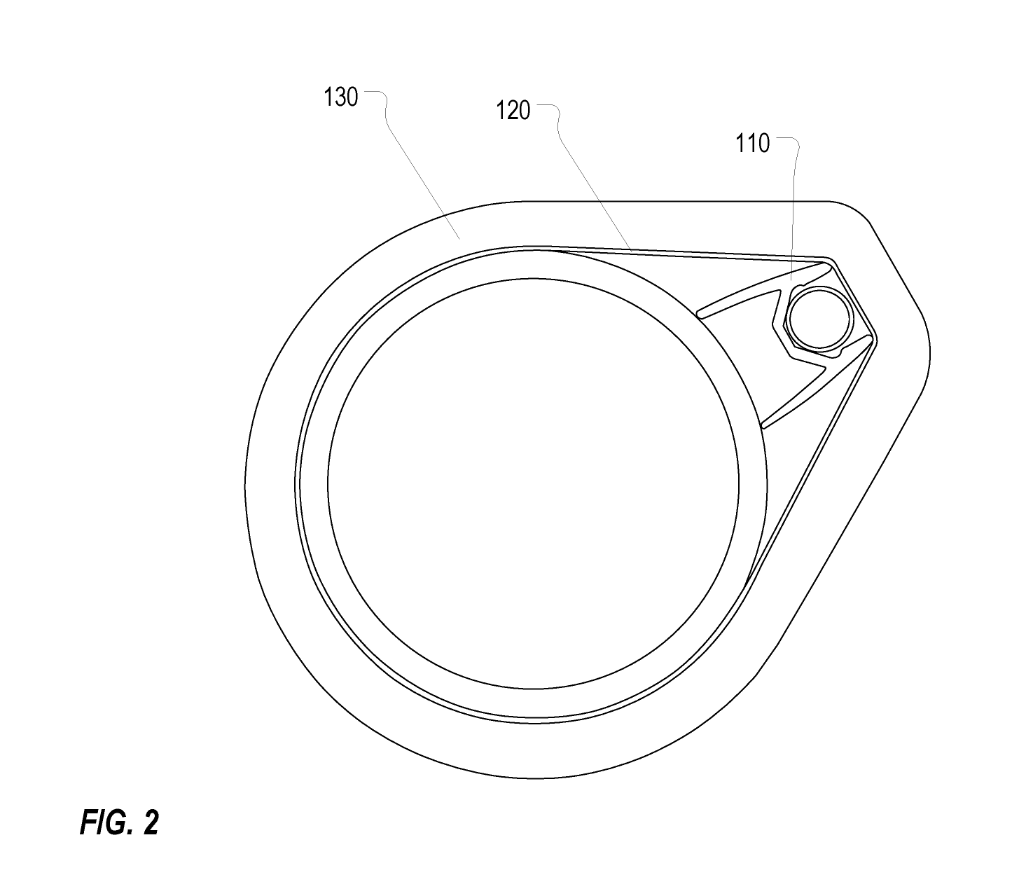

In accordance with one or more preferred implementations, insulation is used together with a standoff apparatus. When insulated, any air space under the insulation is heated and creates an “oven effect” on the pipe surface. This keeps the pipe warm enough to prevent freezing without over-heating its contents. FIG. 2 illustrates an exemplary system utilizing a standoff apparatus 110 and such insulation 130.

In accordance with one or more preferred implementations, standoff apparatus extrusions can be made in various dimensions to accommodate any system, style, or size. In accordance with a preferred implementation, a standoff apparatus has a size profile to fit 2″-12″ schedule 40 pipe.

In accordance with one or more preferred implementations, a standoff apparatus comprises aluminum, although other materials may be utilized in one or more other implementations. Aluminum construction minimizes stainless steel contact with carbon steel pipe, mitigating the effects of galvanic corrosion.

In accordance with one or more preferred implementations, a standoff apparatus receives a thermally resistant polymer coating.

In accordance with one or more preferred implementations, a standoff apparatus is contemplated to be installed on a pipe via use of stainless steel banding, and is designed to elastically deform at stainless steel banding locations when the installation banding is tightened appropriately, keeping the steam trace secured to the standoff without damaging either component's integrity. FIG. 2 illustrates an exemplary system utilizing a standoff apparatus 110 and such banding 120.

The standoff apparatus of FIG. 1 includes leg portions 12 (illustrated as two leg portions, although in accordance with one or more preferred implementations other numbers may be used) designed to elevate a steam trace and make only tangential contact with a pipe surface, thereby minimizing heat transfer from conduction.

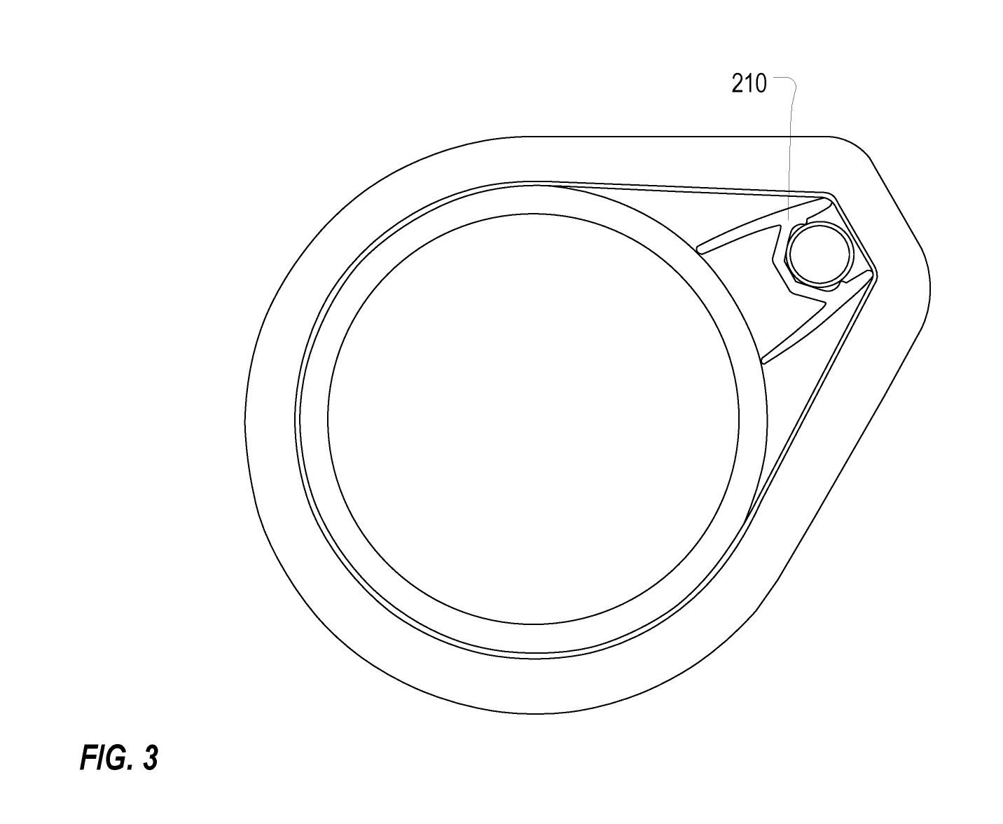

The standoff apparatus 10 of FIG. 1 further includes a trace receiving area configured to receive a trace such as a steam trace. The trace receiving area preferably includes a plurality (three are illustrated) of inwardly curved areas designed to allow the standoff apparatus to make only tangential contact (illustrated as tangential contact at four points) with a received steam trace, thereby minimizing heat transfer from conduction. It will be appreciated that various other designs of trace receiving areas may be utilized. For example, FIG. 2 illustrates a standoff apparatus 110 which is configured for tangential contact with a trace at only two points, while FIG. 3 illustrates a standoff apparatus 210 which is configured for tangential contact with a trace at five points.

It will be appreciated that FIGS. 2 and 3 represent profile views of exemplary systems utilizing a standoff apparatus in accordance with one or more preferred implementations.

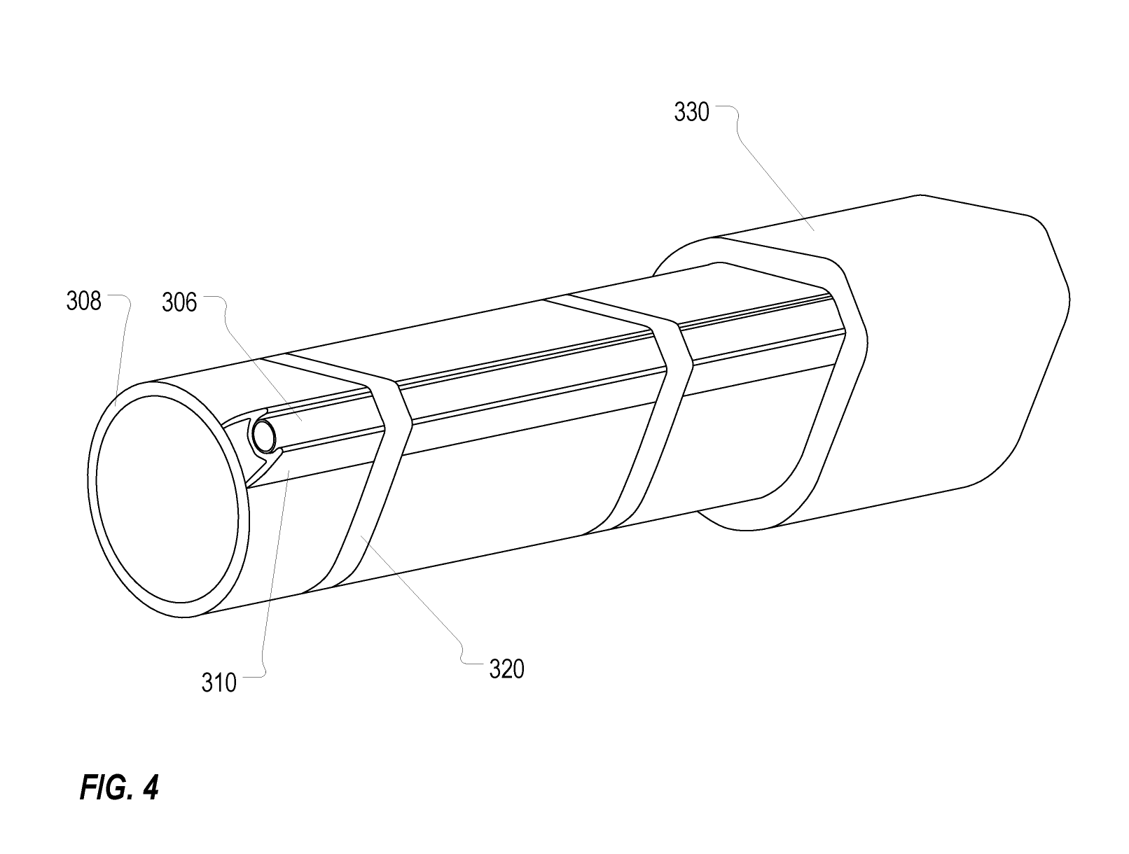

FIG. 4 illustrates a fanciful perspective view of a system utilizing a standoff apparatus 310 in accordance with one or more preferred implementations. The standoff apparatus 310 is secured to a process pipe 308 by stainless steel banding 320. Although for purposes of illustration insulation 330 is only illustrated as extending partially down the length of the standoff apparatus 310, in one or more preferred implementations the insulation 330 preferably extends over most or all of the length of the standoff apparatus 310.

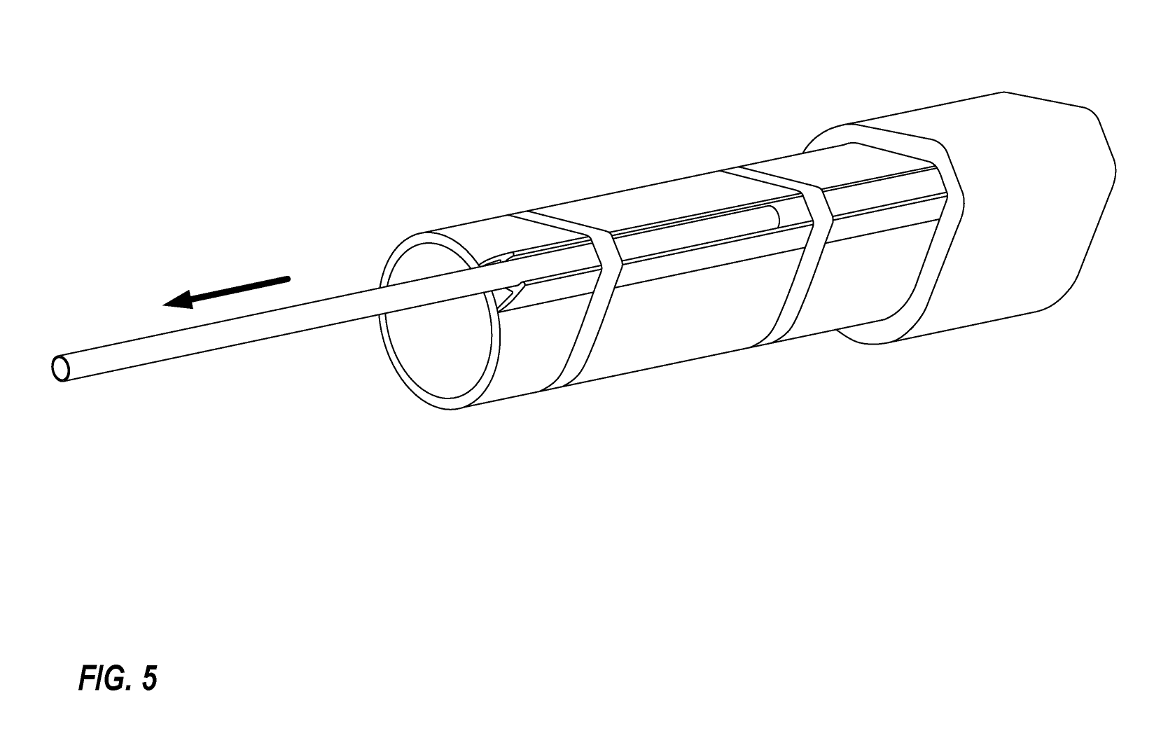

The standoff apparatus 310 is configured to receive a tracer tube within a trace receiving channel. FIG. 4 illustrates a steam trace 306 received within a trace receiving channel of the standoff apparatus. In accordance with one or more preferred implementations, the system is configured to allow for the removal of a tracer tube received within the standoff apparatus without having to remove insulation or banding, as illustrated in FIG. 5. For example, in accordance with one or more preferred implementations, a tracer tube merely rests in the trace receiving channel and is not permanently mated to the standoff apparatus or in contact with banding, thereby allowing for easy withdrawal, aided by the fact that the tracer tube makes only tangential contact with the standoff apparatus. In accordance with one or more preferred implementations, subsequent installation of a new tracer tube can similarly occur without removal of insulation or banding. This can be useful in the case of, for example, a ruptured tracer tube, as a system in accordance with one or more preferred implementations allows for withdrawal of a ruptured tracer tube, and installation of a new tracer tube, without having to remove or unsecure banding or insulation.

Based on the foregoing description, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention. Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements, the present invention being limited only by the claims appended hereto and the equivalents thereof.

1. A system comprising:
(a) a process pipe;
(b) a standoff apparatus secured to the pipe via a plurality of spaced securing bands, the standoff apparatus comprising
(i) a trace receiving channel configured to receive a tracer tube, the trace receiving channel having a profile configured to effect only tangential contact with a tracer tube received within the trace receiving channel, and
(ii) two elevating leg portions;
(c) a tracer received within the trace receiving channel;
(d) insulation surrounding the standoff apparatus and the spaced securing bands, the insulation trapping heat from the tracer received within the trace receiving channel;
(e) wherein, so as to minimize conductive heat transfer from the tracer to the process pipe,
(i) the tracer is not in contact with the process pipe,
(ii) the standoff apparatus contacts the pipe only at the two elevating leg portions, and
(iii) the tracer received within the tracer channel is in only tangential contact with the standoff apparatus.

2. The system of claim 1, wherein the tracer comprises a steam tracer.

3. The system of claim 1, wherein the spaced securing bands comprise stainless steel securing bands.

4. The system of claim 1, wherein the standoff apparatus comprises aluminum.

5. The system of claim 1, wherein the standoff apparatus comprises a thermally resistant polymer coating.

6. The system of claim 1, wherein the process pipe comprises a water pipe.

7. The system of claim 1, wherein the standoff apparatus has a size profile to fit 2″-12″ schedule 40 pipe.

8. A system comprising:
(a) a process pipe;
(b) a standoff apparatus secured to the pipe via a plurality of spaced securing bands, the standoff apparatus comprising
(i) a trace receiving channel configured to receive a tracer tube, the trace receiving channel having a profile configured to effect only tangential contact with a tracer tube received within the trace receiving channel, and
(ii) two elevating leg portions;
(c) a tracer received within the trace receiving channel;
(d) insulation surrounding the standoff apparatus and the spaced securing bands, the insulation trapping heat from the tracer received within the trace receiving channel;
(e) wherein, so as to minimize conductive heat transfer from the tracer to the process pipe,
(i) the tracer is not in contact with the process pipe,
(ii) the standoff apparatus contacts the pipe only at the two elevating leg portions, and
(iii) the tracer received within the tracer channel is in only tangential contact with the standoff apparatus;
(f) wherein the spaced securing bands do not secure the tracer so as to allow the tracer to be withdrawn from the trace receiving channel from a lateral end without removing the insulation or unsecuring the spaced securing bands.

9. The system of claim 8, wherein the tracer comprises a steam tracer.

10. The system of claim 8, wherein the spaced securing bands comprise stainless steel securing bands.

11. The system of claim 8, wherein the standoff apparatus comprises aluminum.

12. The system of claim 8, wherein the standoff apparatus comprises a thermally resistant polymer coating.

13. The system of claim 8, wherein the process pipe comprises a water pipe.

14. The system of claim 8, wherein the standoff apparatus has a size profile to fit 2″-12″ schedule 40 pipe.

15. A method of replacing a tracer without uninstalling insulation comprising:
(I) with respect to a system including
(a) a process pipe;
(b) a standoff apparatus secured to the pipe via a plurality of spaced securing bands, the standoff apparatus comprising
(i) a trace receiving channel configured to receive a tracer tube, the trace receiving channel having a profile configured to effect only tangential contact with a tracer tube received within the trace receiving channel, and
(ii) two elevating leg portions;
(c) a tracer received within the trace receiving channel;
(d) insulation surrounding the standoff apparatus and the spaced securing bands, the insulation trapping heat from the tracer received within the trace receiving channel;
(e) wherein, so as to minimize conductive heat transfer from the tracer to the process pipe,
(i) the tracer is not in contact with the process pipe,
(ii) the standoff apparatus contacts the pipe only at the two elevating leg portions, and
(iii) the tracer received within the tracer channel is in only tangential contact with the standoff apparatus;
(f) wherein the spaced securing bands do not secure the tracer so as to allow the tracer to be withdrawn from the trace receiving channel from a lengthwise end without removing the insulation or unsecuring the spaced securing bands;
(II) withdrawing, from a lengthwise end of the system, the tracer from the trace receiving channel without removing the insulation or unsecuring the spaced securing bands;
(III) inserting, via a lengthwise end of the system, a new tracer into the tracer receiving channel without removing the insulation or unsecuring the spaced securing bands.

16. The method of claim 15, wherein the tracer comprises a steam tracer.

17. The method of claim 15, wherein the spaced securing bands comprise stainless steel securing bands.

18. The method of claim 15, wherein the standoff apparatus comprises aluminum.

19. The method of claim 15, wherein the standoff apparatus comprises a thermally resistant polymer coating.

20. The method of claim 15, wherein the process pipe comprises a water pipe.

21-24. (canceled)
